(19) United States
(12) Patent Application Publication
(10) Pub. No.: US 2015/0093183 A1
(43) Pub. Date: Apr. 2, 2015

(54) LINK CONNECTION STRUCTURE FOR CABLE CARRIER

(71) Applicant: Koduct Co., Ltd., Busan (KR)

(72) Inventor: Sool-Jin Sim, Busan (KR)

(73) Assignee: Koduct Co., Ltd

(21) Appl. No.: 14/395,535

(22) PCT Filed: Apr. 16, 2013
(86) PCT No.: PCT/KR2013/003192

§ 371 Date: Oct. 20, 2014

(30) Foreign Application Priority Data
Apr. 19, 2012 (KR) 10-2012-0041040

(51) Int. Cl. F16G 13/16; F16L 3/015

(52) U.S. Cl. CPC F16G 13/16; F16L 3/015
USPC 403/164

(57) ABSTRACT

One object of the present invention is to provide a link structure for a cable carrier that can be easily assembled and disassembled for higher productivity and convenient maintenance and the track curvature of which can be adjusted conveniently. To achieve the above described object, the link comprises a first circular portion and a second circular portion, wherein the first circular portion is rotationally connected to the adjacent second circular portion of the link and the second circular portion is rotationally connected to the adjacent first circular portion of the link so as to constitute the entire cable carrier. The present invention further comprises a connection member in which an adjustment member is formed so as to be fixedly connected via the front surface of the first circular portion of the link and limit the angle of rotation of the adjacent second circular portion of the link.

### FIELD AND BACKGROUND OF THE INVENTION

The present invention relates to a link connection structure for a cable carrier, and more particularly, to a link connection structure for a cable carrier, which is convenient to assemble and maintain and can control a curvature.

A cable carrier as a part applied to an exterior of an industrial machine serves to cover exteriors of cables or various hoses connected to moving machine parts such as semiconductor equipment, clean room facilities, machine tool robots, various mid and short-distance industrial machines, and the like to protect the cables or various hoses from environmental contamination, prevent the cables or various hoses from damaged by foreign materials, and further, guide transportation while protecting the cables or various hoses from erosion chemicals.

Further, even exteriorly, the cable carrier also plays an additional role of improving merchantability by arranging various cables.

As described above, when the cable carrier transports the cables or various hoses, the cable carrier is bent at some position, the bent portion has a shape of ‘⊂’ or ‘⊃’.

A curvature bent as described above needs to be adjusted according to positions and structures of various facilities, but in the related art, a track curvature in a returned part is limited by a structure in which connectors of links contact each other.

Accordingly, characteristics of an adopted machine are first determined and the curvature of the cable carrier is determined in advance, and the links are manufactured and assembled according to the characteristics and curvature.

The cable carrier is installed and used at a specific place and when controlling the track curvature is required as necessary, adjusting is impossible and a cable carrier suitable for the corresponding curvature can be applied to only a machine having a specific curvature.

A curvature specification of the cable carrier in the related art, is required in industries is first examined, cable carriers having various curvatures need to be produced based on the examined curvature, and further, when the cable carrier is maintained, the corresponding curvature is first determined and a component suitable for the curvature needs to be additionally held, and as a result, a lot of components need to be managed.

In order to solve the disadvantage, specific means of which a curvature is controlled is required, and as a result, Korean Patent Registration No. 897403 to which an element capable of controlling a curvature of a cable bay is added is proposed by the applicant.

The present invention is a component that can control a curvature of a link by inserting a track control member capable of controlling the curvature between links and even the cable by having a different curvature is configured by the same link, and when only the track control member is replaced, it is possible to cope with even a predetermined curvature, and as a result, industrial application is very excellent.

In particular, since the link can be commonized, a lot of convenience is provided to production and maintenance and only the track control member having a relatively smaller than the size of the link may be produced in various specifications, and as a result, epoch-making characteristics are shown in many aspects.

The present invention is very peculiar in adding a concept of the track control member, but according to an embodiment which is actually applied, when the track control member is positioned in the link to repair a specific damaged cable carrier, contiguous links are consecutively separated and the track control member positioned in the link needs to be separately disassembled, and as a result, the maintenance is somewhat difficult and further, it is inconvenient even in an assembling process.

Accordingly, in an assembling step of directly connecting and disconnecting and assembling the track control member outside the link, a new type of cable carrier that can provide improvement of productivity and convenience of maintenance is required.

### SUMMARY OF THE INVENTION

The present invention is contrived to solve the disadvantage in the related art and an object of the present invention is to provide a link connection structure for a cable structure capable of controlling a track curvature, which is easily assembled and disassembled for higher productivity and convenient maintenance.

In order to achieve the above object, in a link connection structure for a cable carrier, a first circular portion and a second circular portion of an adjacent link are rotatably connected by the first circular portion and the second circular portion and the second circular portion is rotatably connected with a first circular portion of the adjacent link to constitute the entire cable carrier, and the link connection structure further includes a connection member having a control member which is fixedly connected through a front surface of the first circular portion of the link to restrict a rotational angle of the second circular portion of the adjacent link.

Preferably, a slot that penetrates the link is formed in the first circular portion, the control member is connected through the slot, a first stopper is formed in the first circular portion, a suspension protrusion is formed in a second circular portion of an adjacent link and the suspension thus rotates between the control member and the stopper to restrict rotation by the control member and the stopper.

More preferably, two slots may be formed at an interval of 180°, total two stoppers may be formed at the center between the slots one by one, respectively, and total two suspension protrusions may be formed between the slot and the stopper one by one.

Preferably, a fixing portion with a protrusion may be included in the side of the slot, and a connection groove receiving the protrusion may be further included in the side of the control member.

More preferably, the connection member may further include a plurality of seating protrusions, and the first circular portion may further include a seating hole connected with the seating protrusion.

More preferably, the first circular portion may further include a connection hole with a guide, the guide may be seated in the second circular portion, a hole penetrating a link may be formed at the center, a guide protrusion with a step may be further included in a rear surface of the hole, and a connection protrusion connected to the step formed in the hole through the hole of the link adjacent to the connection hole may be further included in the connection member.

More preferably, the first circular portion may further include a dented portion receiving the connection member on the front surface thereof so that the connection member does not protrude through the front surface.

Since the link connection structure for a cable carrier according to the present invention includes a connection member that is connected outside the link to control a curvature degree of the cable carrier, two adjacent links are positioned at a connection position and thereafter, just connected with only the combination member to connect the links, and as a result, assemblability is very excellent and further, disconnecting the cable carrier can also separate two adjacent links, thereby providing the convenience of the maintenance and further, since the connection member connects the links to each other by using a plurality of means, connection force is excellent, thereby lowering failure occurrence rate upon operation.

### BRIEF DESCRIPTION OF THE DRAWINGS

FIG. 1 is a perspective view illustrating an embodiment of a cable carrier;

FIG. 2 is a perspective view illustrating a link connection structure according to the present invention;

FIG. 3 is a perspective view illustrating a configuration of a front surface of a link of FIG. 2;

FIG. 4 is a perspective view illustrating a configuration of a rear surface of the link of FIG. 2;

FIG. 5 is a perspective view illustrating a configuration of a connection member of FIG. 2; and

FIG. 6 is a configuration diagram for describing operation states of the link and the connection member of FIG. 2.

### DESCRIPTION OF SPECIFIC EMBODIMENTS OF THE INVENTION

Hereinafter, the present invention will be described in detail with reference to the accompanying drawings.

The entire cable carrier 1 is configured to include link sets 2 in which a plurality of links 10 are connected to each other and connection members 3 which connects the links 10 of each link set 2 in a transverse direction, and various cables are positioned in a space between the link set 2 and the link set 2, as illustrated in FIG. 1.

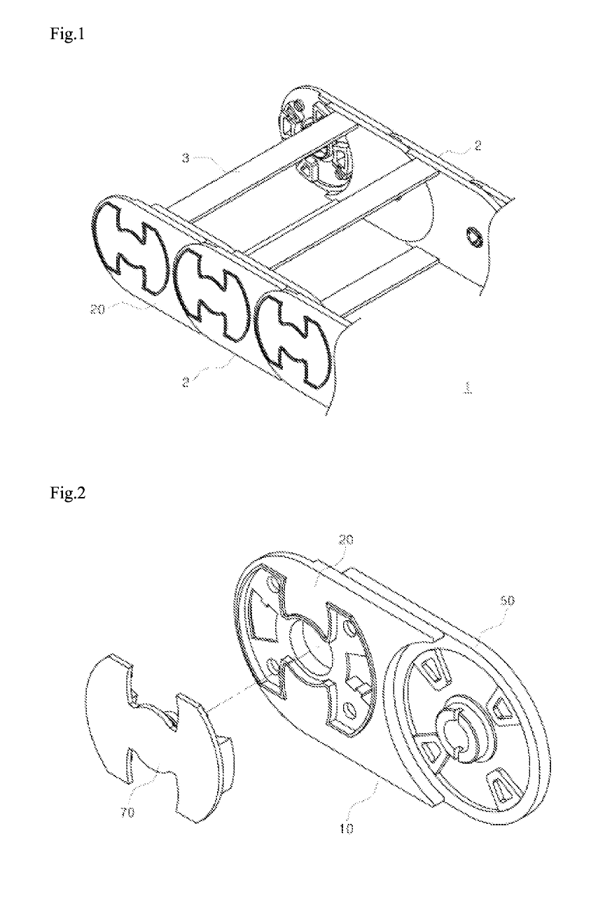

A link connection structure for the cable carrier according to the present invention limits a combination pattern of a link 10 and an adjacent link 10 in FIG. 1 and as illustrated in FIG. 2, the link connection structure is configured to include a link 10 and a connection member 70 connected to the link 10.

Herein, the link 10 serves as a structure of the entire cable carrier 1 and the connection member 70 serves to connect the links 10 and control a curvature of the entire cable carrier 1 by limiting a rotated angle when the link 10 is bent.

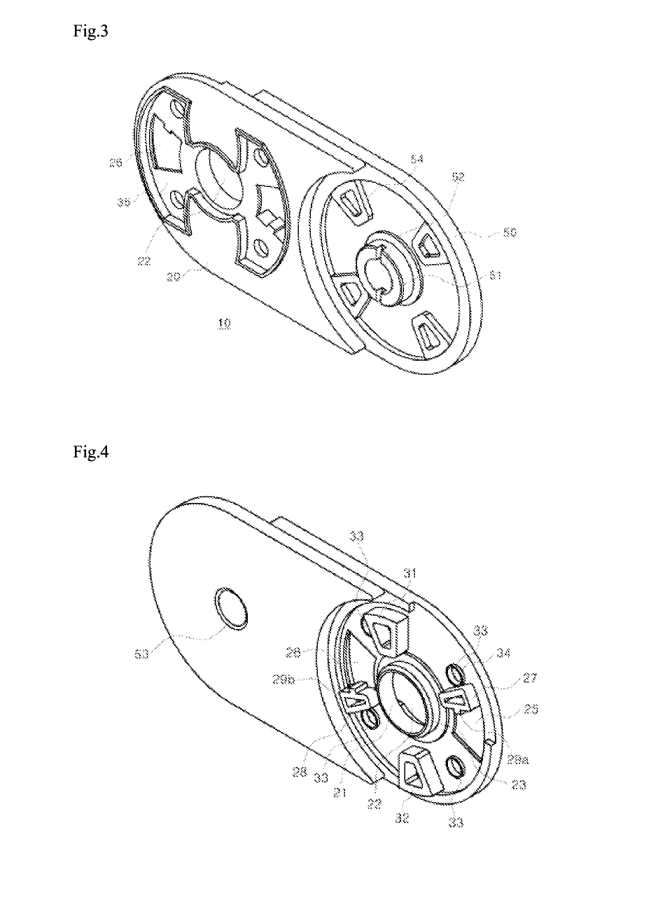

First, the link 10 is constituted by units illustrated in FIGS. 3 and 4 and two adjacent links 10 are connected to each other, and as a result, the entire cable carrier 1 constituted by the plurality of links 10 is configured.

First, the unit link 10 has a structure in which two circles having the same radius are connected to each other and includes a first circular portion 20 having a structural characteristic on a rear surface thereof and a second circular portion 50 having a structural characteristic on a front surface thereof.

Herein, the rear surface of the first circular portion 20 of the unit link 10 is connected with the front surface of the second circular portion 50 of other unit link 10 and similarly, the front surface of the second circular portion 50 is connected with the rear surface of the first circular portion 20 of another adjacent unit link 10.

By this method, the plurality of links 10 are consecutively connected as many as necessary.

A circular connection hole 21 which coincides with the center of the circle is formed on the rear surface of the first circular portion 20 of the link 10. Of course, the connection hole 21 is divided into a through-hole 22 and a guide 23 having a predetermined wall from a through-hole 22 in the link 10. The connection member 70 is connected with the second circular portion 50 of another adjacent link 10 through the through-hole 22 and the guide 23 serves as a guide for relative rotation of the second circular portion 50.

Further, a first slot 25 and a second slot 26 which are through-formed are formed at the same-radius position by a phase difference of 180° from each other, in the first circular portion 20.

Further, a first fixing portion 27 that protrudes on a rear surface is formed on the side of the first slot 25 and a second fixing portion 28 that protrudes on the rear surface is also formed even on the side of the second slot 26. A first protrusion 29a that is vertically formed at the first slot 25 side and a second protrusion 29b is formed on the side of the second slot 26 of the second fixing portion 28. Also, the first fixing portion 27 and the second fixing portion 28 are formed at the same-radius position by the phase difference of 180° from each other.

Further, the first circular portion 20 includes a first stopper 31 that protrudes on the rear surface thereof and a second stopper 32 having the phase difference of 180° from the first stopper 31. The first stopper 31 and the second stopper 32 have the same shape and are positioned at the same height and on the same circumference.

Further, a plurality of through-type seating holes 33 for connecting the connection members 70 is formed in the first circular portion 20 and steps 34 for connecting the connection members 70 are formed on the circumferences of the connection members 70. Two or more seating holes 33 are formed and preferably, four seating holes 33 having a uniform circumferential interval are provided.

Meanwhile, a dented portion 35 having a predetermined width and a predetermined depth of the connection member 70, on which the connection member 70 may be seated is formed on the front surface of the first circular portion 20 and the connection member 70 is seated on the dented portion 35 to maintain the same plane as a cross section of the link 20.

The second circular portion 50 has a characteristic on the front surface thereof, a guide protrusion 51 that is rotatably seated on the guide 23 of the first circular portion 20 is formed at the center of the circle, a through-hole 52 is formed on an inner surface of the guide protrusion 51, and a step 53 is formed on a rear surface of the hole 52.

The connection member 70 is connected to the step 53, which serves to connect adjacent links 10 to each other.

Meanwhile, the step 53 may be omitted as necessary, and in this case, the links 10 may be configured to be connected to each other by forming additional suspension jaws in the guide protrusion 51 and the guide 23.

Further, a plurality of suspension protrusions 54 is formed on the front surface of the second circular portion 50, the suspension protrusion are arranged by the same phase difference, and also, the suspension protrusion 54 have the same size and shape, and the number of the suspension protrusion 54 is preferably 4.

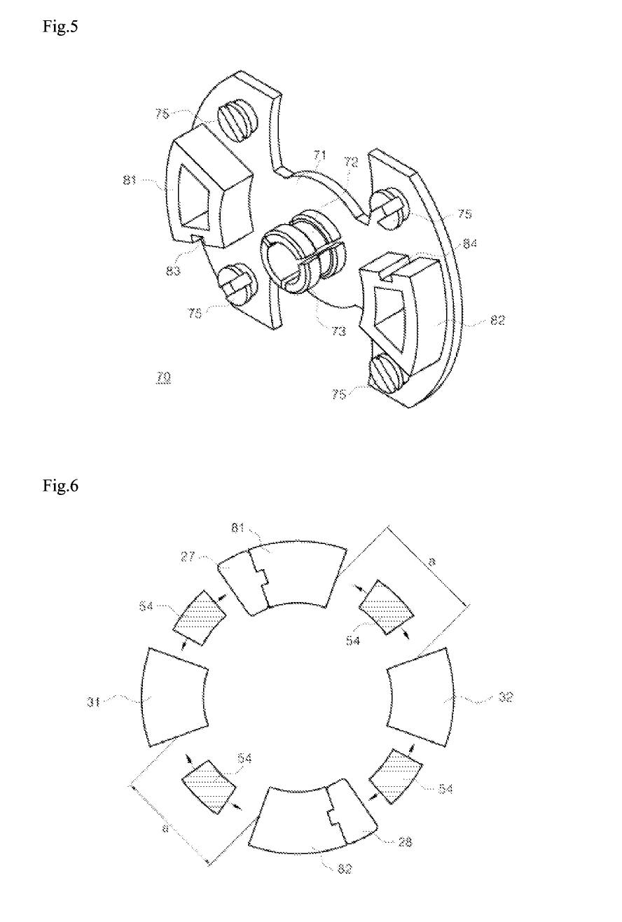

Meanwhile, a plurality of members protrudes based on a flat plate base 71 to form the connection member 70, as illustrated in FIG. 5.

The base 71 has the same shape as the dented portion 35 formed on the front surface of the first circular portion 20 and preferably, the base 71 is seated on the dented portion 35 not to protrude on the front surface of the link 10.

A connection protrusion 72 is formed at the center of the base 71 and a connection end 73 corresponding to the step 53 of the second circular portion 50 is formed on the end of the connection protrusion 72.

Further, the connection protrusion 72 is preferably configured to be multiply cut in a vertical direction for easy connection.

Further, seating protrusions 75 corresponding to the seating holes 33 formed in the first circular portion 20 of the first link 10 are formed in the base 71 as many as the seating holes 33 and steps for connection holding are formed even on the ends of the seating protrusion 75.

In addition, a control member 80 constituted by a first control member 81 and a second control member 82 are formed in the base 71 in order to control the curvature of the link 10.

In addition, a first connection groove 83 is formed on the side of the first control member 81 and further, a second connection groove 84 is formed on the side of the second control member 82.

The control member 81 is inserted into the first slot 25 formed in the first circular portion 20 of the link 10, in which the first protrusion 29a is inserted and fixed into the first connection groove 83, and the second control member 82 is inserted into the second slot 26 formed in the first circular portion 20 of the link 10, in which the second protrusion 29b is also inserted and fixed into the second connection groove 84.

In particular, the first protrusion 29a and the first connection groove 83 are connected to each other with cross sections having a trapezoidal shape and thereafter serve to prevent relative rotation and the second protrusion 29b and the second connection groove 85 are also formed in the same form.

When a connection relationship of the connection member 70 is described, the front surface of the second circular portion 50 of another adjacent link 10 is first connected to the rear surface of the first circular portion 10 of the link 10. A guide protrusion 51 of the second circular portion 50 is seated in the guide 23 of the first circular portion to be rotatably connected.

In addition, four suspension protrusion 54 are positioned between the first fixing portion 27 and the first stopper 31, between the fixing portion 27 and the second stopper 32, between the first stopper 31 an the second fixing portion 28, and between the second stopper 32 and the second fixing portion 28.

In this case, the seating protrusion 75 of the connection member 70 is seated on the connection end 73 of the second circular portion 50 through the link 10 adjacent to the link 10 to rotatably fix the adjacent link 10 to the link 10.

Further, four seating protrusion 75 are fixed to the seating hole 33 of the first circular portion 20.

In addition, the first control member 81 and the second control member 82 are seated on the first slot 25 and the second slot 26, respectively and the entire connection member 70 is fixed to the dented portion 35 formed on the front surface of the first circular portion 20 by connection of the first protrusion 29a and the first connection groove 83 and connection of the second protrusion 29b and the second connection groove 84.

As described above, when the link 10, the connection member 70, and the adjacent link 10 are connected, a rotation part shows a configuration illustrated in FIG. 6.

Herein, when an arc size between the first control member 81 and the second stopper 32 is represented by a, one suspension protrusion 54 is positioned and the suspension protrusion 54 reciprocates between the arc size a.

Moreover, when the second control member 82 is formed between the second control member 82 and the first stopper 31 in the same form as the first control member 82, the arc size also becomes a.

In this case, when widths of arcs of the first control member 81 and the second control member 82 have different sizes, a motion range of the suspension protrusion 54 varies, and as a result, a curvature of the cable carrier is controlled.

Herein, when the first slot 25 and the second slot 26 are set to have sizes to receive the first control member 81 and the second control member 82 which are largest, the first slot 25 and the second slot 26 may receive the connection member 70 with the first control member 81 and the second control member 82 having a predetermined size, and as a result, the curvature may be easily changed when only the connection member 70 is changed.

Meanwhile, the connection member 70 is implemented to be connected through the front surface of the link 10, but the connection member 70 may be implemented to be connected through the rear surface of the link 10 as necessary.

Although a specific preferred embodiment of the present invention has been illustrated and described as described above, the present invention is not limited to the embodiment and the present invention includes all of various embodiments which can be executed within the scope without departing from the spirit of the present invention claimed in the appended claims by those skilled in the art.

What is claimed is:

1. A link connection structure for a cable carrier, wherein:
a first circular portion and a second circular portion of an adjacent link are rotatably connected by the first circular portion and the second circular portion and the second circular portion is rotatably connected with a first circular portion of the adjacent link to constitute the entire cable carrier, and the link connection structure further includes a connection member having a control member which is fixedly connected through a front surface of the first circular portion of the link to restrict a rotational angle of the second circular portion of the adjacent link.

2. The link connection structure for a cable carrier of claim 1, wherein a slot that penetrates the link is formed in the first circular portion, the control member is connected through the slot, a first stopper is formed in the first circular portion, a suspension protrusion is formed in a second circular portion of an adjacent link and the suspension thus rotates between the control member and the stopper to restrict rotation by the control member and the stopper.

3. The link connection structure for a cable carrier of claim 2, wherein two slots are formed at an interval of 180°, total two stoppers are formed at the center between the slots one by one, respectively, and total two suspension protrusions are formed between the slot and the stopper one by one.

4. The link connection structure for a cable carrier of claim 2, wherein:
a fixing portion with a protrusion is included in the side of the slot, and
a connection groove receiving the protrusion is further included in the side of the control member.

5. The link connection structure for a cable carrier of claim 4, wherein:
the connection member further includes a plurality of seating protrusions, and
the first circular portion further includes a seating hole connected with the seating protrusion.

6. The link connection structure for a cable carrier of claim 5, wherein:
the first circular portion further includes a connection hole with a guide,
the guide is seated in the second circular portion,
a hole penetrating a link is formed at the center,
a guide protrusion with a step is further included in a rear surface of the hole, and
a connection protrusion connected to the step formed in the hole through the hole of the link adjacent to the connection hole is further included in the connection member.

7. The link connection structure for a cable carrier of claim 6, wherein the first circular portion further includes a dented portion receiving the connection member on the front surface thereof so that the connection member does not protrude through the front surface.
